(19) United States
(12) Patent Application Publication
(10) Pub. No.: US 2010/0269812 A1
(43) Pub. Date: Oct. 28, 2010

(54) MANUAL CUTTER FOR CERAMIC TILES

(76) Inventor: Josep TORRENTS I COMAS, Barcelona (ES)

Correspondence Address: OSTROLENK FABER GERB & SOFFEN, 1180 AVENUE OF THE AMERICAS, NEW YORK, NY, 100368403, US

(21) Appl. No.: 12/768,138

(22) Filed: Apr. 27, 2010

(30) Foreign Application Priority Data
Apr. 28, 2009 (ES) 200930050

(51) Int. Cl. B28D 1/32

(52) U.S. Cl. 125/23.01

(57) ABSTRACT

The cutter has an adjustable set square (4) for the positioning of the pieces of ceramic and a single driving mechanism (5) that includes an adjustable driving head (6) fitted with a positioner (63) with an eccentric snub (64), some elastic means (65) for the fixing into some seats (41) of the adjustable set square (4) and some means (66) for the height regulation of the positioner (63) in regard to the main body (61). The eccentric snub (64) is coaxially fixed to an axis (64a) allowing the possibility of vertical movement in a lower opening (63a) defined in the positioner (63) and moved laterally in regard to the geometric axis of said positioner; the rotation of the positioner (63) determining a circular movement of the eccentric snub (64) around the geometric axis of the positioner (63) for the adjustment of its angular position.

### OBJECT OF THE INVENTION

This invention refers to a manual tile cutter, being of the type that includes: a base with an upper surface for the support of the piece to be cut, at least a longitudinal rail with their ends fixed to the base and arranged in parallel and on top of the middle longitudinal area of the base, and a carrier handle for the cutting blade or cutting tool, moveable along said longitudinal rail or rails, a set square that can be turned so that it can be positioned on the base for the pieces of tile to be cut with differing angles and some means of fixing the set square that turns on the base in different angular positions.

### BACKGROUND TO THE INVENTION

One of the objects of the manufacturer of the manual ceramic cutter is to provide a positioning device that allows the piece of ceramic to be cut to be positioned with different inclinations against the longitudinal axis of the machine.

In a generalised manner these positioning devices have a piece or set square that can be turned, that is assembled onto the base of the machine with the possibility of rotating and some means of fixing said adjustable piece in the required angular position in line with the cutting line or mark to be placed on the piece of ceramic tile.

It is also normal for the adjustable piece to have a moveable ruler at its front end that can be moved laterally and is fixable by some means of tightening.

Currently different registration backgrounds are known for manual ceramic cutters that include the stated adjustable piece for the positioning of the ceramic tiles to be cut with differing angles, and which are focussed on the means for the fixing of said adjustable piece in the required position.

In patent ES2064248 belonging to the same owner as this present invention, it refers to a positioning device on machines for cutting-separating the flat pieces of ceramic and similar, that include a fixed limiter ruler located at one end of the machine, an element that is moveable along a guide and a rotating element or piece that is connected to the lineally moveable piece, said positioning device having some means for the fixing of the adjustable or rotating element in the required position.

In the example of the embodiment shown in said invention patent it can be seen that the rotating element or piece has a curved groove with a range of some 45°, in which a lever is assembled for the fixing of the adjustable element into the required position.

In said patent, once having positioned the adjustable element it only requires the lever to be tightened so as to guarantee the fixing of the adjustable element that determines the support angle of the piece of ceramic to be cut.

In the stated patent of invention ES2064248, the rotating element also has a graduated ruler which, at its free end, has a stop element and at the other side of the ruler there is an extension that has a flat plane that is appreciably perpendicular to the ruler, together with this there is a set square for the making of the angle of the tiles or ceramic pieces to be cut.

In the Italian patent of invention IT1330295 a machine for cutting tiles is described, with an adjustable set square, which is characterised in that it has a mobile blocking device fixed to said variable angle set square, having a handle and a contrasting element, interacting with a support base surface fitted with a curved opening.

This solution is similar to that described in the patent ES2064248 mentioned previously.

Additionally, in the Italian patent IT1330295 the machine to cut the tile has some grooves for the angular measuring, set into the base of the machine, these are characterised because they have some devices set on the variable angle set square so as to interfere in a voluntary manner with said grooves and to set the fixing position of the adjustable set square.

The patent PCT WO2007/110458A1 belonging to the same owner as this present invention, refers to a manual ceramic cutter that has an adjustable set square for the positioning of the pieces of tile to be cut, and for the fixing of said adjustable set square there are some conical seats made in the base of the cutter for the optional housing of the conical point of an assembled pin with the possibility of vertical movement on the adjustable set square, which allows the set square to be fixed in any of the positions defined by the stated conical seats.

Additionally, this cutter includes a vertical push flange, opposite the upper surface of the adjustable set square, said flange having an driving lever that has an adjustable height pusher at its front end fitted with a coating of an elastic material at the end opposite the upper surface of the adjustable set square and an driving lever between an operating position in which the pusher applies pressure on the adjustable set square and a non-operational position in which the pusher releases the adjustable set square.

The use of some first devices made up of a pin that fits in the seats or recesses that determine angular positions of the adjustable set square and the use of some second devices for the applying of pressure and fixing of the adjustable set square in any angular position means a complication when the operator is using the tile cutter, who must activate the first devices separately that allows the adjustable set square to be fixed in some specific positions and the second devices that allow the fixing of the adjustable set square in any angular position. Another of the disadvantages of the cutters that have the stated first fixing devices made up of a snug that are inserted into some seats or recesses comes from the manufacturing tolerances themselves for the pieces obtained by casting and the tolerances in machining, which frequently causes the snug to be introduced into one of the seats or recesses, for example that which makes the 0° angle not corresponding exactly with the real position of the adjustable set square in the cutter, systematically producing errors of misalignment in the cuts made with the machine, regardless of the angular position chosen in the adjustable set square.

In utility model 200900031, belonging to the same owner as this present invention, a ceramic cutter is described that has some constructive peculiarities in which reference is made to the fixing means of the adjustable set square, aimed at simplifying their action for the operator and preventing the angular differences between the theoretical and real positions of the adjustable set square determined by the manufacturing and/or machining tolerances of the means used to set the fixing of the adjustable set square in some specific angular positions. The solution proposed in said utility model 200900031 consisted of adding a single driving mechanism that allows for the fixing of the adjustable set square in some pre-established angular positions, determined by some seats made in the upper surface of the adjustable set square and, that also allows the adjustable set square to be fixed in any of the angular positions possible within its rotating circle, this means at those angles that do not correspond to the seats made in the upper surface of the adjustable set square.

In said utility model 200900031 the single driving mechanism has a mobile driving head assembled with the possibility of height regulation on a series of jointed driving levers assembled in a fixed position in regard to the cutter base. Said driving head consists of:—a main body assembled with the possibility of vertical adjustment in respect of the driving lever for the set of jointed levers and a carrier for the friction element that is intended to drive the adjustable set square surface, its fixing being in any angular position;—a positioning device assembled in the main body with the possibility of vertical movement and which has an eccentric snub on its lower end that can be positioned angularly and which is suitable for insertion into any of the seats of the adjustable set square establishing the fixing in the corresponding angular position;—some elastic means that are used to keep the eccentric snub in the lower position of placement in the seats of the adjustable set square and;—some devices for the height regulation of the eccentric snub against the main body. With these elements, it is possible: to alter the height of the main body and consequently of the entire driving head in respect of the driving lever, to alter the height of the actuator in respect of the main body, and to alter the orientation of the eccentric snub around the axis of the head, placing it in a reference position for the purpose of guaranteeing that on introducing the eccentric snub in one of the seats of the adjustable set square, said adjustable set square remains fixed in the machine exactly with the angle corresponding to said seat, even though the seats have a certain angular difference compared to the real angle marked compared to the front support surface of the piece of tile to be cut, this is because the rotation of the snub allows for an initial calibration of the machine to rotate it to the degree in the amount necessary to compensate for possible differences of the seats of the adjustable set square compared to the angles corresponding to same.

However, the differing height adjustments of the main body and the actuator, and the orientation of the eccentric snub have a certain complexity for the operator who is not familiar with these regulations, an excessive amount of time might be lost in the preparation of the machine or to achieve an incorrect regulation with the resulting errors in the marking and cutting of the pieces of ceramic.

Therefore, the technical problem that is posed is the development of a ceramic cutting machine that is based on the same working principles as the machine described in the stated utility model 200900031 from the same owner that allows for a simpler adjustment of the driving head, especially in so far as the positioning of the eccentric snub that allows for the compensation of the possible angular offsetting between the position of the recesses of the adjustable set square and the angular positions that theoretically correspond to said recesses.

### DESCRIPTION OF THE INVENTION

The manual ceramic cutter, object of the invention is of the type that includes a base with an upper surface for the support of the piece of ceramic to be cut, at least one longitudinal rail onto which a carrier handle for the cutting tool blade is mounted and having the possibility of longitudinal movement, an adjustable set square for the positioning of the pieces of ceramic to be cut with different angles and a single driving mechanism for the fixing of the adjustable set square, said single driving mechanism being made up of a mobile driving head arranged above the upper surface of the adjustable set square and assembled with the possibility of height adjustment on a set of jointed levers assembled in a fixed position against the cutter base; said driving head having: a main body assembled with the possibility of vertical adjustment in respect of the driving lever and a carrier for the friction element that is intended to drive the adjustable set square surface, its fixing being in any angular position; a positioning device assembled in the main body and which has an eccentric snub on its lower end that can be positioned angularly and which is suitable for insertion into any of the seats of the adjustable set square establishing the fixing in the corresponding angular position;—some elastic means that keep the eccentric snub in the lower position of placement in the seats of the adjustable set square and;—some devices for the height regulation of the eccentric snub against the main body.

According to the invention the stated eccentric snub is common and coaxial to an axis assembled with the possibility of vertical movement in a lower opening made in the positioner and moved laterally in regard to the geometric axis of said positioner that in turn is assembled on a thread on the main body of the driving head, determining the rotation of the positioner in regard to the main body for a circular movement of the eccentric snub around the geometric axis of the positioner for the adjustment of its angular position.

Another characteristic of the invention is that the elastic means, used to move the eccentric snub towards a lower position are arranged in the lower opening of the positioner acting with the opposite ends against the upper wall of said opening and against the upper end of the carrier axis of the eccentric snub. In this way the eccentric snub and the axis fixed coaxially to said snub can be moved vertically in regard to the positioner without protruding over its rear area and without the need for any adjustment in a vertical direction by the operator.

According to the invention, on the upper end of the positioner there is a head for the fixing of a tool activated by rotating, for example an Allen type key, said head having some means for the adjustment of the angular position of the actuator and consequently the eccentric snub assembled in the lower opening of said actuator. With the stated characteristics the adjustment of the driving head is very easy: Its height adjustment is achieved simply by screwing the main body on the driving lever to a greater or lesser degree, and the angular position of the eccentric snub is achieved by rotating the actuator to a maximum angle of 360°, which is achieved by rotating with suitable key onto the head defined on the upper end of the actuator.

It can be seen that by means of this adjustment the driving head is at a suitable height when activating the driving levers, the friction element assembled on the main body exercises sufficient pressure on the upper surface of the adjustable set square to guarantee its securement in any angular position. Additionally, in order to adjust the angular position of the eccentric snub it is enough to introduce it into one of the upper recesses of the adjustable set square and to rotate the positioner in one direction or another, acting on its upper head, until the adjustable set square really reaches the angular position corresponding to the stated recess.

### DESCRIPTION OF THE FIGURES

In order to complete the description that is being made and for the purpose of providing a better understanding of its characteristics, a set of drawings is attached to this present description in which the figures being by way of illustration and are not by way of limitation on the invention, in which the following is shown:

FIG. 1 shows a perspective view of an example of an embodiment of the ceramic cutter object of the invention fitted in this case with a single longitudinal rail for the movement of the blade or cutting tool carrier handle.

FIG. 2 shows a detail in perspective of the end of the cutter corresponding to an adjustable set square and the single driving mechanism.

FIG. 3 shows an elevation view of the same end of the sectioned cutter from a vertical plane in which the eccentric snub of the driving head is housed in one of the seats made in the upper surface of the adjustable set square.

FIG. 4 shows an expanded detail of the single driving mechanism in the operating position and the adjustable set square rotated, and retained in any angular position by the action of the friction element, the eccentric snub can be seen in the elevated position and supported on the upper surface of the adjustable set square.

FIG. 5 shows a similar view as the previous figure with the single driving mechanism in a non-operational situation.

FIG. 6 shows an expanded elevation view of the driving head, sectioned along a vertical plane.

FIG. 7 shows a schematic overhead view of the adjustable set square, in which the upper recesses have an offsetting angle (a) in regard to the adjustable set square and in which the eccentric snub is housed in one of the recesses positioning the adjustable set square in an incorrect angular position with a mistake that is the same as the stated offsetting angle.

FIG. 8 shows a similar view as the previous with the eccentric snub rotated to the degree that is necessary to offset the offsetting angle (a) of the recesses, and housed in one of said recesses, fixing the adjustable set square in a correct position and corresponding to the theoretical position with said recess.

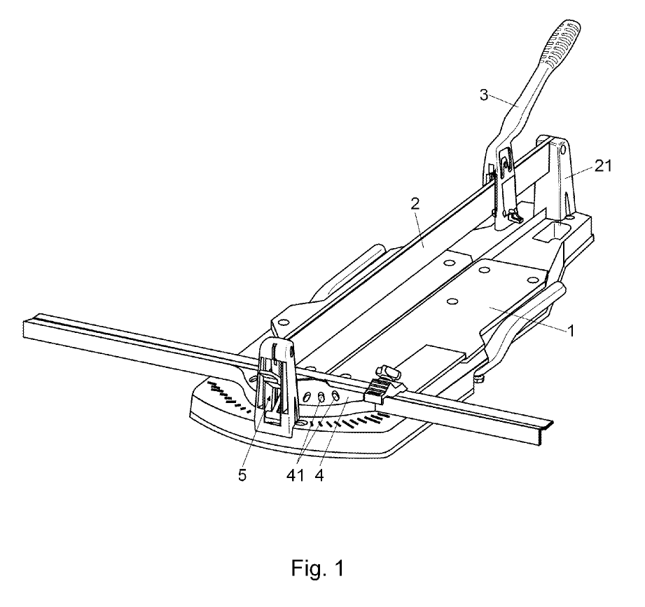

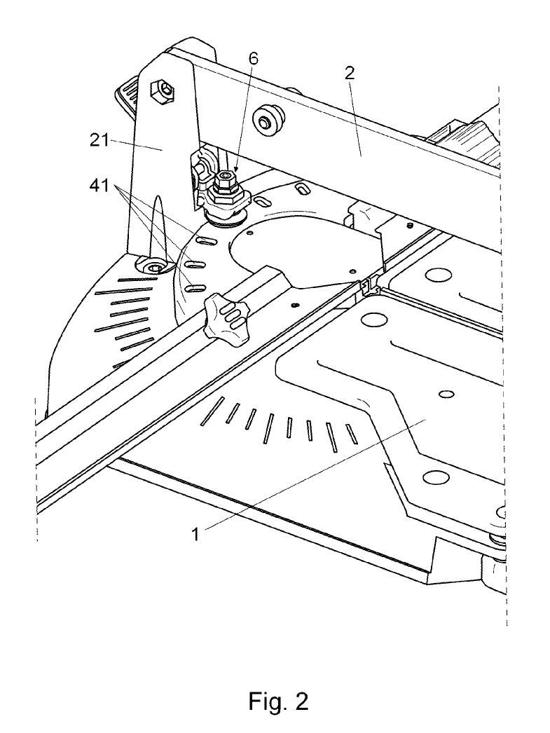

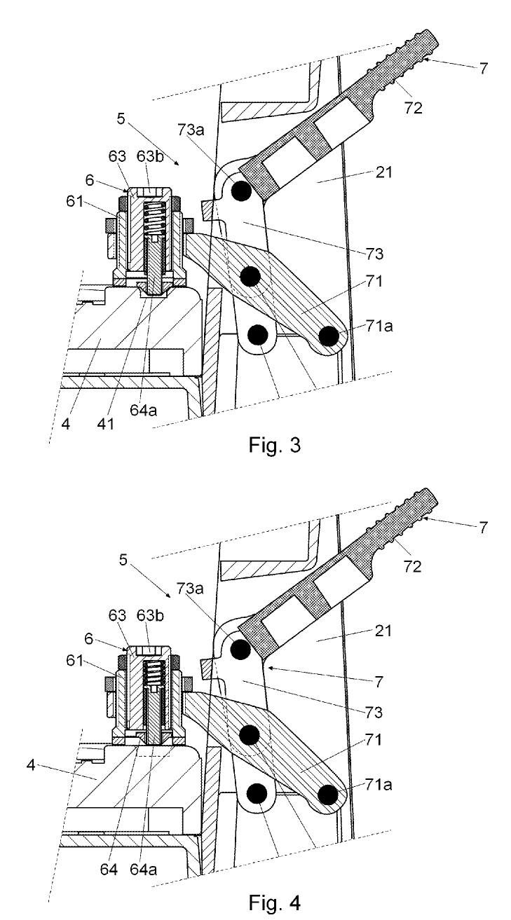

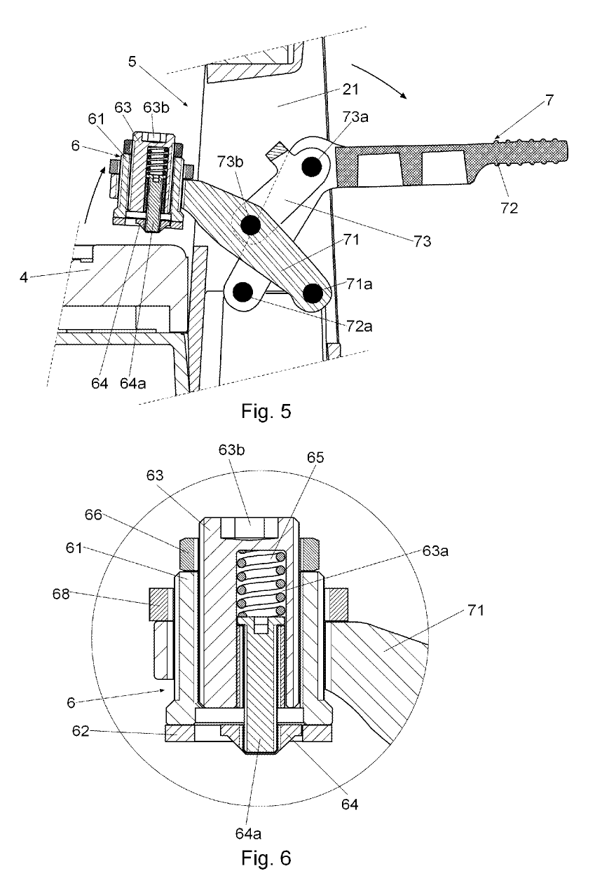

### PREFERRED EMBODIMENT OF THE INVENTION

As can be seen in the attached figures, the cutter is made up from a base (1) onto which the longitudinal rail (2) for the movement of a handle (3) that carries the blade or cutting tool is fixed by means of end supports (21). An adjustable set square (4) is assembled onto the base (1) for the positioning of the pieces of ceramic to be cut at different angles on the base.

The cutter is made up of a single driving mechanism (5) for the fixing of the adjustable set square (4) both in pre-established angular positions, determined by some seats (41) defined in the upper surface of the adjustable set square (4) and equally any of the possible angular positions of its rotating circle.

The single driving mechanism (5) is made up of an driving head (6) fitted above the upper surface of the adjustable set square (4) and assembled on a set of jointed levers (7) assembled in a fixed position in regard to the cutter base (1), specifically in one of the supports (21) of the longitudinal rail (2); the set of jointed levers (7) having an driving lever (71) and a manual driving lever (72) assembled at one of its ends along both rotating axes (71a, 72a) and an intermediate jointed lever (73) at the other ends by means of both rotating axes (73a, 73b) on two intermediate points of the driving lever (72) and the driving lever (71) respectively.

The driving head (6) is made up of a main body (61) assembled on a thread in the driving lever (71) of the set of levers (7) and which has a friction element (62) fitted at the bottom which is intended to act against the surface of the adjustable set square (4) fixing it in any angular position that is possible on the base of the cutting machine. The fixing of the main body (61) to the height required in respect of the driving lever (71) is established by means of the tightening nut (68).

Said driving head is also made up of a positioner (63) fitted to a thread on the main body (61) and which has a lower opening (63a) that is offset into which the eccentric snub (64) is fitted through a coaxial axis (64a), this can be moved vertically on the inside of said lower opening (63a) and some elastic means (65) that let the eccentric snub (64) move in a lower locking position in any of the seats (41) of the adjustable set square (4) establishing the fixing in the corresponding angular position.

Said positioner (63) has a head (63b) at its upper end for the coupling of a rotating driving tool, said head (63b) having some devices to alter the angular position of said positioner and the eccentric snub assembled to same, which allows the angular position of the adjustable set square (4) to be adjusted in the case of the recesses (41) defined in same having an offsetting angle in regard to the theoretical positions of said recesses.

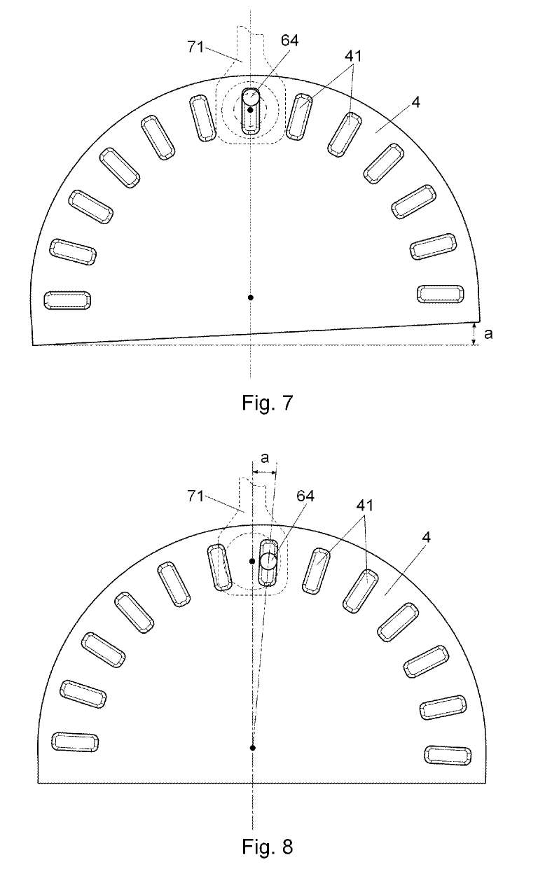

In FIGS. 7 and 8 the recesses of the adjustable set square are moved an angle (a) from the positions indicated by same, in such a way that if the eccentric snub is arranged in a position corresponding to zero degrees and it is housed in the recess of the adjustable set square corresponding to zero degrees, the front surface of the adjustable set square has a wrong inclination corresponding to the stated offsetting angle (a).

By means of the rotation of the positioner and consequently the eccentric snub to the degree necessary it is obtained, as shown in FIG. 8, to compensate the offsetting angle (a) of the recesses (41) and in so doing guaranteeing that on introducing the eccentric snub (64) in any of the recesses, the adjustable set square is really arranged in the angular position corresponding to said recess (41).

Once having sufficiently described the nature of the invention, likewise having given a preferred embodiment it is placed on record that the materials, shape, size and arrangement of the elements described can be modified provided that they do not mean an alteration of the basic essentials of the invention that are claimed below.

1-3. (canceled)

4. A manual cutter for tiles comprising:
a base having an upper surface for the support of a tile to be cut;
an adjustable set square at the upper surface of the base for positioning tile to be cut at different angles, the set square also having an upper surface and a plurality of seats for positions of the set square for different cut angles of tile; and
a driving mechanism configured for fixing positions of the adjustable set square, the driving mechanism comprising:
a mobile driving head arranged above the upper surface of the adjustable set square;
a set of jointed levers assembled in a fixed position against the cutter base, the mobile driving head being assembled with the set of levers which are configured to enable height adjustment caused by the set of levers;
the driving head including a main body assembled with one of the driving levers and configured for vertical adjustment in respect of the one driving lever,
a friction element configured to act on the adjustable set square surface to fix the upper surface of the set square at any angular position;
a carrier for the friction element;
a positioning device above the seats of the set square, the positioning device including an eccentric snub on a lower end thereof, the snub is positionable angularly with respect to the base and is configured for insertion into any of the seats of the adjustable set square for establishing fixing of the set square in a corresponding angular position of the seat;
the eccentric snub is coaxially fixed to an axis and the snub is configured for possible vertical movement with respect to the positioning device and the snub has been moved laterally and eccentrically in regard to a geometric axis of said positioning device, whereby a rotation of the positioning device causes a circular movement of the eccentric snub around the geometric axis of the positioning device for adjusting the angular position of the snub in regard to the base; and
a cutting tool or blade for cutting tile.

5. Cutter, according to claim 4, further comprising an elastic device configured and located to keep the eccentric snub in a lower position of placement of the snub in a selected seat of the adjustable set square.

6. Cutter, according to claim 4, wherein the positioning device has a head at an upper end thereof configured for coupling to a rotating driving tool, the head including an adjustment device for adapting the angular position of the positioning device and of the eccentric snub fitted to the positioning device.

7. Cutter, according to claim 6, further comprising a device for height regulation of the positioning device against the set square.

8. Cutter, according to claim 4, further comprising a device for height regulation of the positioning device against the set square.

9. Cutter, according to claim 4, further comprising at least one longitudinal rail arranged parallel, a carrier handle for the cutting tool or blade that is moveable on said at least one longitudinal rail.

10. Cutter, according to claim 5, further comprising the elastic device being arranged in a lower opening of the positioning device, the elastic device having opposite ends acting respectively against an upper wall of said opening and against an upper end of the axis of the eccentric snub.

11. Cutter, according to claim 4, further comprising an opening in the positioning device, opening toward the upper surface of the set square and in which the snub is vertically moveable.
